(19) United States
(12) Patent Application Publication
(10) Pub. No.: US 2013/0124736 A1
(43) Pub. Date: May 16, 2013

(54) APPARATUS AND METHOD FOR SETTING AUTO CONNECTION OF SENSOR NODE BASED ON SENSOR DATA

(71) Applicants: Il Kyun PARK, Gwangiu-si (KR); Seung Chul Son, Gwangiu-si (KR); Sim Kwon Yoon, Gwangiu-si (KR); Byung Tak Lee, Suwon-si (KR); Young Sun Kim, Daejeon (KR)

(72) Inventors: Il Kyun PARK, Gwangiu-si (KR); Seung Chul Son, Gwangiu-si (KR); Sim Kwon Yoon, Gwangiu-si (KR); Byung Tak Lee, Suwon-si (KR); Young Sun Kim, Daejeon (KR)

(73) Assignee: Electronics and Telecommunication Research Institute, Daejeon (KR)

(21) Appl. No.: 13/614,462

(22) Filed: Sep. 13, 2012

(30) Foreign Application Priority Data
Nov. 10, 2011 (KR) 10-2011-0116802

(51) Int. Cl. G06F 15/16

(52) U.S. Cl. 709/227

(57) ABSTRACT

Provided is an apparatus and method for setting a sensor node to be automatically connected. An apparatus for setting a connection of a sensor node may include: a data receiver to receive, from the sensor node, sensor data that is measured by the sensor node; a node type determining unit to determine a type of the sensor node based on the received sensor data; and a sensor node setting unit to set the sensor node to be automatically connected based on the determined type of the sensor node.

### CROSS-REFERENCE TO RELATED APPLICATION

This application claims the priority benefit of Korean Patent Application No. 10-2011-0116802, filed on Nov. 10, 2011, in the Korean Intellectual Property Office, the disclosure of which is incorporated herein by reference.

### BACKGROUND

1. Field of the Invention

The present invention relates to an apparatus and method for setting a connection of a sensor node, and more particularly, to an apparatus and method for setting a connection of a sensor node that may support a connection automation function even in a low performance sensor node incapable of having the connection automation function or an old sensor node that does not have the connection automation function.

2. Description of the Related Art

Sensors including an infrared (IR) sensor have been utilized using various methods and thus, there is a need for a method that may automate a connection between a sensor node installed with a sensor and a management node, for example, a server.

An Institute of Electrical and Electronics Engineers (IEEE) 1451 standard relates to an interface between a management node and a sensor node to collect sensor data for factory automation, and discloses a method that may manage sensor data generated by a sensor node in a form of transducer electronic datasheets (TEDS), and may perform a plug-and-play (PNP) based automatic connection between a management node including an Network Capable Application Processor (NCAP) module and a sensor node a transducer interface module (TIM).

However, in the IEEE 1451 standard, the automatic connection may be performed only in the sensor node including the TIM. Accordingly, the automatic connection may not be performed in an old sensor to which the TIM cannot be added, or a low performance sensor node incapable of executing the TIM.

Accordingly, there is a need for a method that may automate a connection of a sensor node by adding a configuration to the sensor node, or by automatically determining a type of the sensor node while not being affected by performance of the sensor node.

### SUMMARY

An aspect of the present invention provides an apparatus and method that may determine a type of a sensor node based on sensor data and thereby support a connection automation function in the sensor node regardless of performance of the sensor node.

According to an aspect of the present invention, there is provided an apparatus for setting a connection of a sensor node, the apparatus including: a data receiver to receive, from the sensor node, sensor data that is measured by the sensor node; a node type determining unit to determine a type of the sensor node based on the received sensor data; and a sensor node setting unit to set the sensor node to be automatically connected based on the determined type of the sensor node.

When the sensor analysis data having the same format as the received sensor data is not retrieved, the node type determining unit may determine the type of the sensor node by analyzing a pattern of sensor data.

When the type of the sensor node is not determined by analyzing the pattern of sensor data, the node type determining unit may request the sensor node to transmit additional sensor data, and may determine the type of the sensor node based on the transmitted additional sensor data.

The sensor node connection setting apparatus may further include a sensor node setting unit to be automatically connected to the sensor node using a plug-and-play (PNP) scheme based on the determined type of the sensor node.

According to another aspect of the present invention, there is provided a method of setting a connection of a sensor node, the method including: receiving sensor data that is measured by the sensor node; determining a type of the sensor node based on the received sensor data; and setting the sensor node to be automatically connected based on the determined type of the sensor node.

### EFFECT

According to embodiments of the present invention, a remote terminal unit having relatively excellent performance or sufficient size compared to a sensor node may determine a type of the sensor node based on sensor data and may register the sensor node to be automatically connected. Accordingly, it is possible to support a connection automation function even in a low performance sensor node incapable of having the connection automation function or an old sensor node that does not have the connection automation function, for example, a plug-and-play (PNP) function.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a relationship between a sensor node connection setting apparatus and other apparatuses according to an embodiment of the present invention;

FIG. 2 is a block diagram illustrating a sensor node connection setting apparatus according to an embodiment of the present invention;

FIG. 3 illustrates an example of interface profile data according to an embodiment of the present invention;

FIG. 4 illustrates an example of sensor analysis data according to an embodiment of the present invention;

FIG. 5 illustrates sensor data when a request for transmitting additional sensor data is received according to an embodiment of the present invention;

FIG. 6 is a flowchart illustrating a method of setting a connection of a sensor node according to an embodiment of the present invention; and

FIG. 7 is a flowchart illustrating a process of determining a type of a sensor node of FIG. 6 according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures. A method of setting a connection of a sensor node according to an embodiment of the present invention may be performed by a sensor node connecting setting apparatus.

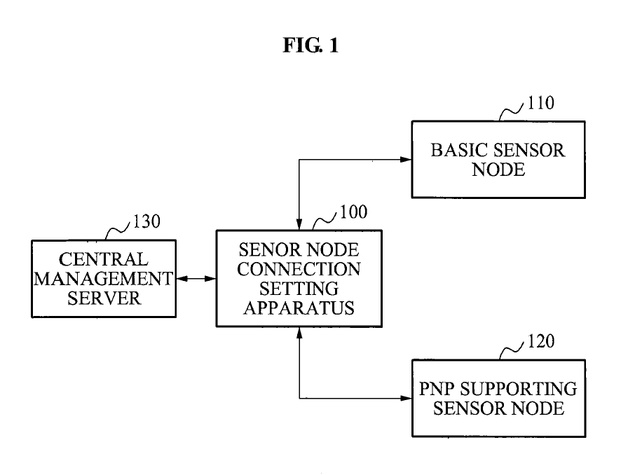

FIG. 1 is a diagram illustrating a relationship between a sensor node connection setting apparatus 100 and other apparatuses according to an embodiment of the present invention.

Referring to FIG. 1, the sensor node connection setting apparatus 100 according to an embodiment of the present invention may receive, from a basic sensor node 110 or a plug-and-play (PNP) supporting sensor node 120, sensor data that is measured by each sensor node, and may transmit the received sensor data to a central management server 130. Here, the sensor node connection setting apparatus 100 may be a remote terminal unit (RUT).

The basic sensor node 110 may be a sensor node that may generate sensor data by measuring a change in a predetermined peripheral value using a sensor. For example, the basic sensor node 110 may be an infrared (IR) sensor node that may measure IR emitted by an animal using an IR sensor, and may also be a noise sensor node that may measure a sound wave using a noise sensor. The basic sensor node 110 may also be a light sensor node that may measure a change in light using a light sensor.

Here, the PNP supporting sensor node 120 may be a sensor node including a PNP unit to perform a PNP function. Here, the PNP unit of the PNP supporting sensor node 120 may perform initialization when the PNP supporting sensor node 120 is driven, and may perform an operation for an automatic connection with the RUT.

However, since at least a reference value of power consumption or physical magnitude needs to be used in order to perform the initialization and operation, it may be difficult to add the PNP unit to a temperature sensor node, a humidity sensor node, a global positioning system (GPS) node, and a sensor node in a simple structure such as a door lock apparatus.

Here, the sensor node connection setting apparatus 100 may determine a type of a sensor node using sensor data that is received from the basic sensor node 110 or the PNP supporting sensor node 120 and thereby register the sensor node. Accordingly, without requesting the sensor node to perform the initialization and operation, the basic sensor node 110 or the PNP support sensor node 120 may be automatically connected to the sensor node connection setting apparatus 100.

Also, the central management server 130 may collect and thereby manage the sensor data that is collected by a plurality of sensor node connection setting apparatuses 100.

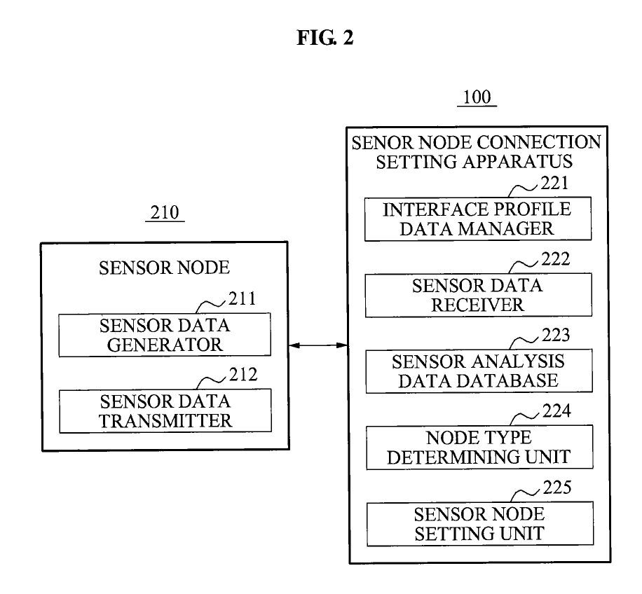

FIG. 2 is a block diagram illustrating the sensor node connection setting apparatus 100 according to an embodiment of the present invention.

Referring to FIG. 1, the sensor node connection setting apparatus 100 according to an embodiment of the present invention may be connected to a sensor node 210, and may include an interface profile data manager 221, a sensor data receiver 222, a sensor analysis data database 223, a node type determining unit 224, and a sensor node setting unit 225.

The sensor node 210 may include a sensor data generator 211 to generate sensor data by measuring a change in a predetermined peripheral value using a sensor, and a sensor data transmitter 212 to transmit the sensor data using a communication interface. Also, the sensor node 210 may periodically transmit sensor data based on a type of the sensor node 210 or a sensor, and may also transmit sensor data when a request is received from the sensor node connection setting apparatus 100 or the central management server 130. Information associated with a setting in which the sensor node 210 transmits sensor data may be included in interface profile data corresponding to the sensor node 210.

The interface profile data manager 221 may generate and manage interface profile data that includes information associated with an interface used by the sensor data transmitter 212 of the sensor node 210 and information associated with an operation setting of the sensor node 210. Here, the interface profile data generator 221 may generate interface profile data based on a manufacturer or a standard document of the sensor node 210.

For example, when the sensor node 210 is connected to the sensor node connection setting apparatus 100 using a universal asynchronous receiver/transmitter (UART) serial interface and communicates with the sensor node connection setting apparatus 100 at a baud rate of 9600, the interface profile data manager 221 may generate information associated with a single interface profile by matching a baud rate of 9600 with the UART serial interface. Also, when a new sensor node is added at a baud rate of 115200, the interface profile data manager 221 may generate new interface profile data by matching a baud rate of 115200 with an interface used by the new sensor node.

The sensor data receiver 222 may receive, from the sensor node 210, sensor data that is measured and thereby generated by the sensor node 210. Here, the number of sensor nodes 210 may be at least one. The sensor data receiver 222 may determine whether to transmit a sensor data request message to the sensor node 210, based on the interface profile data, and may transmit the sensor data request message to the sensor node 210 based on the determination result.

The sensor analysis data database 223 may store and manage sensor analysis data that is a result obtained by analyzing predetermined sensor data. Also, the sensor analysis data may be reference data used to determine a type of the sensor node 210 having transmitted the sensor data.

Here, for each type of the sensor node 210, the sensor analysis data may include at least one of a type of interface profile data used by the sensor node 210, a length of sensor data, a format of sensor data, and a type and a range of a data value for each area that is included in the format of sensor data.

The node type determining unit 224 may determine the type of the sensor node 210 based on the received sensor data.

The node type determining unit 224 may search the sensor analysis data database 223 for sensor analysis data having the same format as the received sensor data.

When the sensor analysis data having the same format as the received sensor data is retrieved from the sensor analysis data database 223, the node type determining unit 224 may determine a sensor node type corresponding to the retrieved sensor analysis data as the type of the sensor node 210 that is connected to the sensor node connection setting apparatus 100.

On the contrary, when the sensor analysis data having the same format as the received sensor data is not retrieved from the sensor analysis data database 223, the node type determining unit 224 may analyze the sensor data and determine the type of the sensor node 210 based on the analysis result. For example, when each byte value of sensor data is an ASCII code and includes “0” through “9” and “.” as the analysis result of the sensor data, the node type determining unit 224 may determine that the sensor data is real-number type information that includes a point. Here, the node type determining unit 224 may determine whether the sensor data is temperature/humidity data or measurement data that is measured by other sensors based on the range of a real-number value, and may determine a type of a sensor node having measured corresponding data as the type of the sensor node 210.

However, when a predetermined pattern is absent in the sensor data, the node type determining unit 224 may be incapable of determining the type of the sensor node 210 based on the analysis result of the sensor data.

When the node type determining unit 224 is incapable of determining the type of the sensor node 210 based on the analysis result of sensor data, the node type determining unit 224 may determine that the sensor data is insufficient, and may request the sensor node 210 to transmit additional sensor data. In this case, the node type determining unit 224 may determine the type of the sensor node 210 based on the transmitted additional sensor data.

The sensor node setting unit 225 may set the sensor node 210 to be automatically connected based on the type of the sensor node 210 that is determined by the node type determining unit 224. Here, the sensor node setting unit 225 may register the sensor node 210 based on the determined type of the sensor node 210, and may automatically access at least one pre-registered sensor node using a PNP.

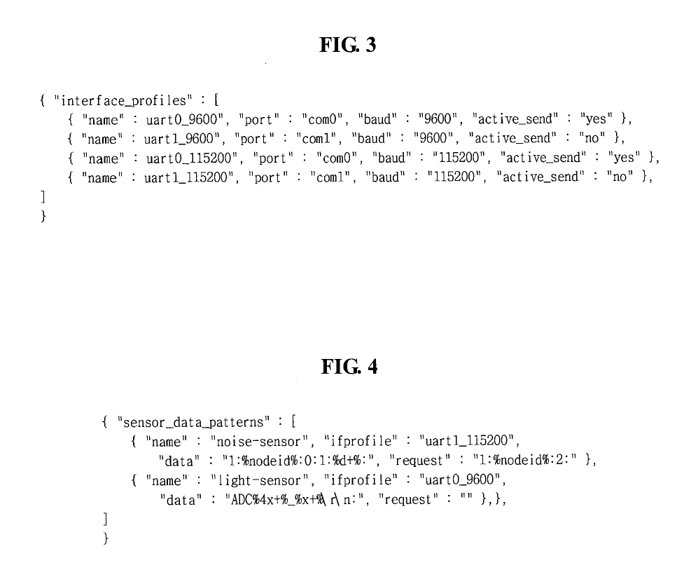

FIG. 3 illustrates an example of interface profile data according to an embodiment of the present invention.

FIG. 3 illustrates an example of interface profile data that is generated using a javascript object notation (JSON) format.

Here, as shown in FIG. 3, the interface profile data may be generated to include separate interface profile data, such as “uart0_{—}9600”, “uart1_{—}9600”, “uart0_{—}115200”, and “uart1_{—}115200”, based on each interface type and setting.

Each profile data may include an interface port, rate data, and information regarding whether sensor data is periodically transmitted or is transmitted as a response to a separate request. For example, in FIG. 3, “port” may indicate the interface port, “baud” may indicate the rate data, and “active-send” may indicate information regarding whether the sensor data is periodically transmitted or is transmitted as a response to a separate request.

As one example, “uart0_{—}9600” interface profile data may indicate that COM0 port is used and 9600 baud rate is used. Also, active-send is yes and thus, may indicate that the sensor data is periodically transmitted even though a sensor data request message is absent.

As another example, “uart1_{—}9600” interface profile data may indicate that the rate is the same as “uart0_{—}9600” interface profile data, but COM1 port is used, and the sensor data is transmitted as a response to a request message only when the sensor data request message is transmitted.

FIG. 4 illustrates an example of sensor analysis data according to an embodiment of the present invention.

As shown in FIG. 4, the sensor analysis data may include “name” that indicates a type of a sensor node, “ifprofile” that indicates a name of an interface profile used by the sensor node, “data” that indicates a pattern of sensor data, and “request” that indicates a format of a sensor data request signal message.

Referring to FIG. 4, sensor data transmitted from a sensor node of a noise sensor may be detected from “uart1_{—}115200” interface profile. Also, the sensor data transmitted from the sensor node of the noise sensor may be data in which “1:”, node ID data, “:0:1”, a decimal number of at least a single digit, and “:” are sequentially listed.

In the case of “uart1_{—}115200” interface profile, only when a sensor data request message is transmitted, sensor data may be transmitted as a response to the sensor data request message and thus, the sensor data request message may be required. Accordingly, a format of the sensor data request message may need to be included in “request”.

Based on information included in “request”, the sensor data request message to be transmitted so that the sensor data receiver 222 may receive the sensor data may be information in which “1:”, sensor node ID, and “:2:” are sequentially listed.

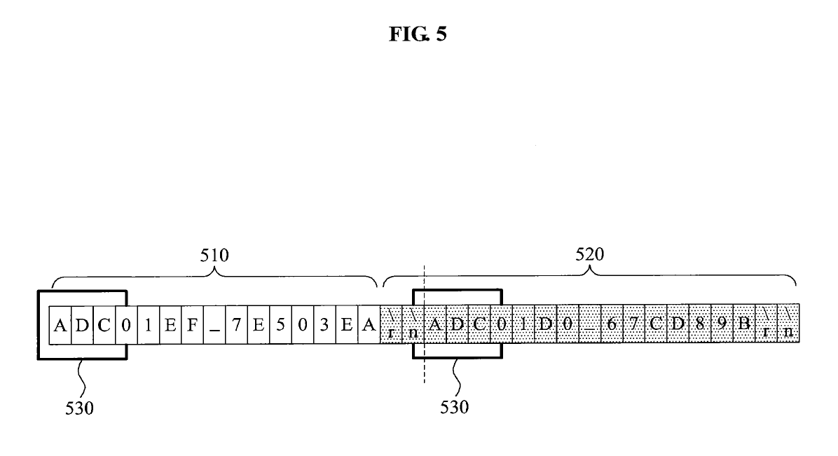

Also, sensor data transmitted from a sensor node of a light sensor may be detected from “uart1_{—}9600” interface profile, and may be information in which “ADC”, a four-digit hexadecimal number, at least one “_” of a hexadecimal number, and “\r\n” are sequentially listed. Here, as shown in FIG. 4, in the case of “uart0_{—}9600” interface profile, sensor data is periodically transmitted and thus, the sensor data request message may not be required. Accordingly, as shown in FIG. 5, “request” may be absent in sensor data that is transmitted from the sensor node of the light sensor.

FIG. 5 illustrates sensor data when a request for transmitting additional sensor data is received according to an embodiment of the present invention.

FIG. 5 illustrates an example of a case in which sensor data transmitted from a sensor node of a light sensor requires additional transmission.

The sensor data transmitted from the sensor node of the light sensor may be information in which “ADC”, a four-digit hexadecimal number, at least one “_” of a hexadecimal number, and “\r\n” are sequentially listed, as shown in FIG. 4. That is, the sensor data transmitted from the sensor node of the light sensor needs to end with “\r\n”.

However, as shown in FIG. 5, depending on a communication state or other conditions, the sensor data receiver 222 may receive incomplete sensor data 510. Here, when comparing a format of the sensor data 510 with a format of sensor data transmitted from the sensor node of the light sensor, end portions are different from each other. Accordingly, the node type determining unit 224 may not determine the sensor data 510 as sensor data that is transmitted from the sensor data of the light sensor.

However, a remaining format excluding the end portion in the sensor data 510 is the same as the sensor data transmitted from the sensor node of the light sensor and thus, the node type determining unit 224 may request the sensor node 210 to transmit additional sensor data. Here, sensor data 520 additionally received from the sensor node 210 may further include a portion that is absent in the sensor data 510.

Here, the node type determining unit 224 may identify a complete format of sensor data based on the repeating occurrence of an “ADC” pattern 530 that is a first part of the format of sensor data that is transmitted from the sensor node of the light sensor. Also, the node type determining unit 224 may compare the identification result with the format of sensor data that is transmitted from the sensor node of the light sensor and thereby determine that the sensor node 210 is the sensor node of the light sensor.

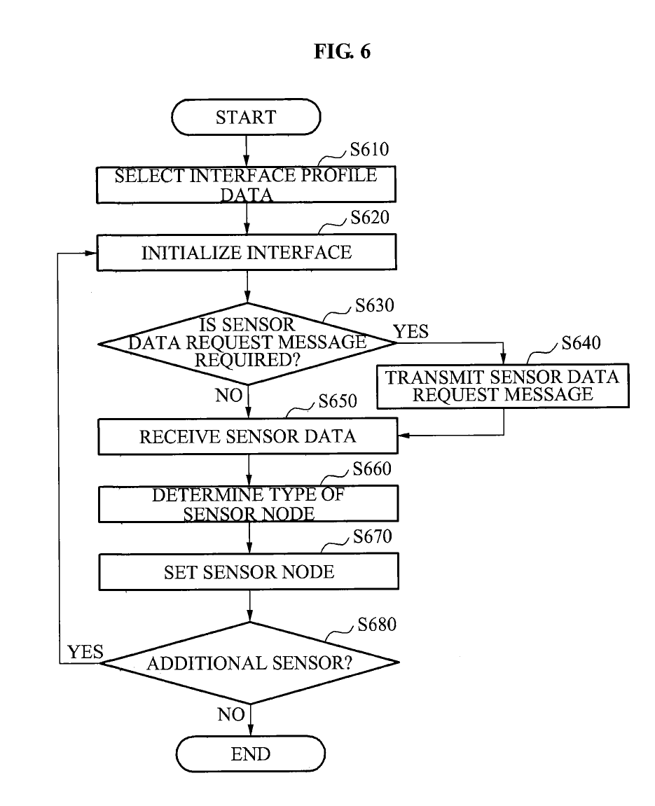

FIG. 6 is a flowchart illustrating a method of setting a connection of a sensor node according to an embodiment of the present invention.

In operation S610, the sensor data receiver 222 may select interface profile data included in the interface profile data manager 221.

In operation 5620, the sensor data receiver 222 may identify and initialize an interface to be used for connection with the sensor node 210, based on the selected interface profile data.

In operation 5630, the sensor data receiver 222 may determine whether to transmit a sensor data request message to the sensor node 210 based on the selected interface profile data. When the sensor node 210 is determined to not require the sensor data request message, the sensor data receiver 222 may wait for receiving sensor data that is periodically transmitted from the sensor node 210 without performing an additional operation.

On the contrary, when the sensor node 210 is determined to require the sensor data request message in operation 5630, the sensor data receiver 222 may transmit the sensor data request message to the sensor node 210 in operation 5640.

In operation 5650, the sensor data receiver 222 may receive, from the sensor node 210, sensor data that is measured and generated by the sensor node 210. Here, the sensor data received by the sensor data receiver 222 may be sensor data that is periodically transmitted by the sensor node 210, or may be sensor data that is transmitted from the sensor node 210 in response to the sensor data request message transmitted in operation S640.

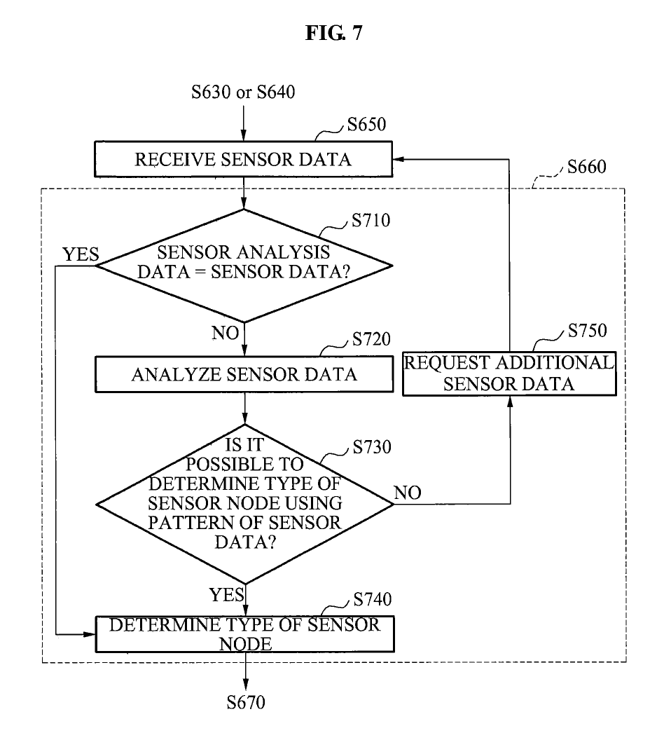

In operation 5660, the node type determining unit 224 may determine a type of the sensor node 210 based on the sensor data received in operation 5650. Hereinafter, a process of determining the type of the sensor node 210 will be further described with reference to FIG. 7.

In operation 5670, the sensor node setting unit 225 may set the sensor node 210 to be automatically connected based on the determined type of the sensor node 210. Here, the sensor node setting unit 225 may register the sensor node 210 based on the type of the sensor node 210 that is determined by the node type determining unit 224, and may automatically access at least one pre-registered sensor node using a PNP.

In operation 5680, the sensor node setting unit 225 may determine whether there is an un-registered additional sensor node, and may perform operation S610 only when there is the additional sensor node.

FIG. 7 is a flowchart illustrating a process of determining a type of a sensor node of FIG. 6 according to an embodiment of the present invention. Here, operations 5710 through S750 of FIG. 7 may be included in operation S660 of FIG. 6.

In operation 5710, the node type determining unit 224 may search the sensor analysis data database 223 for sensor analysis data having the same format as sensor data that is received in operation 5650.

Here, when the sensor analysis data having the same format as the received sensor data is retrieved from the sensor analysis data database 223, the node type determining unit 224 may determine a sensor node type corresponding to the retrieved sensor analysis data as the type of the sensor node 210 that is connected to the sensor node connection setting apparatus 100 in operation 5740.

On the contrary, when the sensor analysis data having the same format as the received sensor data is not retrieved from the sensor analysis data database 223, the node type determining unit 224 may analyze the sensor data in operation S720.

In operation S720, the node type determining unit 24 may identify a type or a value of sensor data by analyzing the sensor data, and may search for a sensor corresponding to the identified type or value.

For example, when the sensor data is real-number type information that includes a point, the node type determining unit 224 may search for a sensor corresponding to the range of a real-number value.

In operation S730, the node type determining unit 224 may verify whether it is possible to determine the type of the sensor node 210 using a pattern of the sensor data that is verified by analyzing the sensor data in operation S720. Specifically, when a predetermined pattern is absent in the sensor data received in operation S650, or when the sensor corresponding to the identified type or value is not retrieved in operation 5720, the node type determining unit 224 may determine that it is not possible to determine the type of the sensor node 210 using the pattern of the sensor data.

Here, the node type determining unit 224 may determine that the sensor data is insufficient and may request the sensor node to transmit additional sensor data in operation S750. Here, the node type determining unit 224 may determine the type of the sensor node 210 based on the transmitted additional sensor data.

In operation S740, the node type determining unit 224 may determine, as the type of the sensor node 210, a sensor node type corresponding to sensor analysis data having the same format as the sensor data received in operation S650, or a sensor node type corresponding to the analysis result of the sensor data.

According to embodiments of the present invention, a remote terminal unit having relatively excellent performance or sufficient size compared to a sensor node may determine a type of the sensor node based on sensor data and may register the sensor node to be automatically connected. Accordingly, it is possible to support a connection automation function even in a low performance sensor node incapable of having the connection automation function or an old sensor node that does not have the connection automation function, for example, a PNP function.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An apparatus for setting a connection of a sensor node, the apparatus comprising:
a data receiver to receive, from the sensor node, sensor data that is measured by the sensor node;
a node type determining unit to determine a type of the sensor node based on the received sensor data; and
a sensor node setting unit to set the sensor node to be automatically connected based on the determined type of the sensor node.

2. The apparatus of claim 1, wherein the node type determining unit searches for sensor analysis data having the same format as the received sensor data, and determines the type of the sensor node based on the search result.

3. The apparatus of claim 2, wherein, for each type of the sensor node, the sensor analysis data comprises at least one of a type of interface profile data used by the sensor node, a length of sensor data, a format of sensor data, and a type and a range of a data value for each area that is included in the format of sensor data.

4. The apparatus of claim 2, wherein when the sensor analysis data having the same format as the received sensor data is not retrieved, the node type determining unit determines the type of the sensor node by analyzing a pattern of sensor data.

5. The apparatus of claim 4, wherein when the type of the sensor node is not determined by analyzing the pattern of sensor data, the node type determining unit requests the sensor node to transmit additional sensor data, and determines the type of the sensor node based on the transmitted additional sensor data.

6. The apparatus of claim 1, wherein the data receiver determines whether to transmit a sensor data request message to the sensor node based on interface profile data, and transmits the sensor data request message to the sensor node based on the determination result.

7. The apparatus of claim 6, wherein the interface profile data comprises information associated with an interface used by the sensor node and information associated with an operation setting of the sensor node.

8. A method of setting a connection of a sensor node, the method comprising:
receiving sensor data that is measured by the sensor node;
determining a type of the sensor node based on the received sensor data; and
setting the sensor node to be automatically connected based on the determined type of the sensor node.

9. The method of claim 8, wherein the determining comprises searching for sensor analysis data having the same format as the received sensor data, and determining the type of the sensor node based on the search result.

10. The method of claim 9, wherein, for each type of the sensor node, the sensor analysis data comprises at least one of a type of interface profile data used by the sensor node, a length of sensor data, a format of sensor data, and a type and a range of a data value for each area that is included in the format of sensor data.

11. The method of claim 9, wherein the determining comprises determining the type of the sensor node by analyzing a pattern of sensor data when the sensor analysis data having the same format as the received sensor data is not retrieved.

12. The method of claim 11, wherein the determining comprises requesting the sensor node to transmit additional sensor data, and determining the type of the sensor node based on the transmitted additional sensor data when the type of the sensor node is not determined by analyzing the pattern of sensor data.

13. The method of claim 8, wherein the receiving comprises determining whether to transmit a sensor data request message to the sensor node based on interface profile data, and transmitting the sensor data request message to the sensor node based on the determination result.

14. The method of claim 13, wherein the interface profile data comprises information associated with an interface used by the sensor node and information associated with an operation setting of the sensor node.
